(19) United States
(12) Patent Application Publication
(10) Pub. No.: US 2008/0067393 A1
(43) Pub. Date: Mar. 20, 2008

(54) Radiation detector for X-rays or gamma rays

(76) Inventors: Wilhelm Metzger, Munich (DE); Khanh Pham Gia, Neubiberg (DE)

Correspondence Address: HARNESS, DICKEY & PIERCE, P.L.C., P.O.BOX 8910, RESTON, VA, 20195, US

(21) Appl. No.: 11/802,003

(22) Filed: May 18, 2007

(30) Foreign Application Priority Data
May 19, 2006 (DE) 10 2006 023 732.3

(51) Int. Cl. G01T 1/20

(52) U.S. Cl. 250/370.11

(57) ABSTRACT

A radiation detector for X-rays or gamma rays is disclosed. In at least one embodiment, the radiation detector includes an array of scintillation detectors and a reflector layer that separates the latter from one another and is formed essentially by a binding agent matrix and particles, incorporated therein, of a light-reflecting material. Further, the reflector layer is interspersed with microcavities.

### PRIORITY STATEMENT

The present application hereby claims priority under 35 U.S.C. §119 on German patent application number DE 10 2006 023 732.3 filed May 19, 2006, the entire contents of which is hereby incorporated herein by reference.

### FIELD

Embodiments of the invention generally relate to a radiation detector for X-rays or gamma rays. For example, in at least one embodiment a detector, which may be used in computer tomography for example, comprises a detector array having a multiplicity of scintillators. A scintillator, in turn, consists of a scintillator material that absorbs gamma radiation or X-radiation and converts it into visible light. Examples of scintillator materials considered are, for example, materials such as Gd₂O₂S:Pr or CsI:Tl doped with activators such as Pr or Tl. The light emitted by the scintillators is recorded by photodetectors, and the corresponding electric signals are further processed, for example for the purpose of image reconstruction in the case of computer tomography. The pixel sizes of a detector array lie in the range of 1 mm×1 mm.

In present-day computer tomographs, the scintillators are arranged in the form of two-dimensional arrays whose flat plane is perpendicular to the central axis of an incident radiation cone. In order to ensure a high image resolution, it is necessary to prevent a lateral propagation of the light signals of the individual scintillators.

Consequently, these are separated from one another with the aid of a reflector layer. This layer is intended to have a high reflectivity and a low absorptance and transmittance for the scintillation light, in order to ensure a high light yield and a low level of cross talk of the light signals with neighboring detectors. A reflector layer usually consists of a binding agent matrix to which there are added particles with a high refractive index, for example of TiO₂, ZnO, MgO or BaSO₄.

### SUMMARY

In at least one embodiment, the invention includes a radiation detector for X-rays and gamma rays having a reflector layer that is improved with regard to reflection, absorption and/or transmission of scintillation light.

In at least one embodiment, this is achieved by virtue of the fact that the binding agent matrix and reflector layer are interspersed with microcavities. This firstly reduces the fraction of binding agent and, consequently, the absorption of scintillation light. In the case of a further effect, which improves the optical properties of the reflector layer, an increased jump in the refractive index comes about between the individual particles and the binding agent matrix that surrounds them and is interspersed with microfine cavities, and thus an increase in the reflectivity of the reflector layer comes about. It is particularly advantageous when the microcavities have a size of 0.1 μm to 1 μm.

It has now emerged that, first and foremost, the last-named effect is particularly strongly expressed in the case of an inorganic binding agent matrix, in particular in the case of waterglass. The evaporation of water after a waterglass slurry has been poured into the columns of a detector array results in cavities that are in direct contact with the surface of particles, that is to say without the interposition of a binding agent layer. In addition to waterglass, it is also possible to use inorganic binding agents such as magnesia cement, Unna's paste, phosphate binder, or else other binders such as polysiloxanes.

TiO₂ particles are preferably present as optically refracting particles. However, apart from this particles of ZnO, MgO and BaSO₄ are also suitable.

With regard to the improvement expected in reflection, it is advantageous here when the particles have a grain size of less than 5 μm. The microcavities are formed by an additive that is added to the binding agent matrix in its flowable initial state and produces gas or is transformed into a gaseous state.

Consideration is given here above all to water, which can, if appropriate, serve at the same time as solvent for the binding agent matrix. However, it is also possible to consider substances that produce or generate gases such as carbon dioxide, for example at increased temperatures or in the presence of a reaction partner. The fraction of the microcavities in the total volume of the reflector layer can be up to 20% by volume.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In describing example embodiments, specific terminology is employed for the sake of clarity. However, the disclosure of this patent specification is not intended to be limited to the specific terminology so selected and it is to be understood that each specific element includes all technical equivalents that operate in a similar manner. As used herein, the terms “and/or” and “at least one of” include any and all combinations of one or more of the associated listed items.

In an example embodiment, a slurry was produced comprising 45% by volume and 75.7% by weight of TiO₂ powder, having a grain size of less than 5 μm and 55% by volume and 24.3% by weight of water. In order to obtain a viscosity adequate for pouring into the columns of a detector array without difficulty, 2 to 4% by weight of dispersant (Disperbyk 180, Byk-Chemie, D-46462, Wesel, Germany) were added to the slurry (referred to the amount of titanium oxide). The dispersant set the viscosity to a value of approximately 7000 mPaxs (plate and cone method, room temperature). Added to this mixture as inorganic binder was 5 to 10% by weight of soda waterglass, referred to the quantity of titanium oxide. For test purposes, this slurry was poured onto rectangular plates with a thickness of 5 mm, a width of 30 mm and a length of 40 mm, which were subsequently dried at 100° C. The evaporation of the water produced many fine microcavities, although high strength accompanied by good incorporation of the titanium oxide particles was ensured, nevertheless.

A commercially available Monte Carlo program was used to calculate the light yield of a model scintillator or model pixel, in the case of which the reflector layer was assumed to have a thickness of 80 μm with a filling level of 45% by volume of titanium oxide. It was further assumed in an idealized way that all the interspaces between the titanium oxide particles consist of air.

In this case, an increase in light yield of 33% was calculated by comparison with a reflector layer that consisted exclusively of a two-component epoxy resin as embedding medium. This increase is based, first, on the larger jump in refractive index between the titanium oxide particles and air or the gas present in a microcavity, and, second, on the negligible absorption of light by the medium present in the microcavities. By comparison with conventional reflector layers having two-component epoxy resin as binding agent and a titanium oxide filling level of 25% by volume, the increase in the light yield is even 42%.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A radiation detector for X-rays or gamma rays, comprising:
an array of scintillation detectors; and
a reflector layer to separate the array of scintillation detectors from one another, the reflector layer being formed essentially by a binding agent matrix and particles, incorporated therein, of a light-reflecting material, the binding agent being selected from the group of the inorganic binding agents, and the reflector layer being interspersed with microcavities.

2. The radiation detector as claimed in claim 1, wherein the microcavities have a clear width of 0.1 μm to 1 μm.

3. The radiation detector as claimed in claim 1, wherein the binding agent matrix is formed from waterglass.

4. The radiation detector as claimed in claim 1, wherein particles of TiO₂ are contained in the binding agent matrix.

5. The radiation detector as claimed in claim 4, wherein the particles have a size of less than 5 μm.

6. The radiation detector as claimed in claim 1, wherein the microcavities are formed by an additive that is added to the binding agent matrix in its flowable initial state and at least one of produces gas and is transformed into a gaseous state.

7. The radiation detector as claimed in claim 2, wherein the binding agent matrix is formed from waterglass.

8. The radiation detector as claimed in claim 2, wherein particles of TiO₂ are contained in the binding agent matrix.

9. The radiation detector as claimed in claim 8, wherein the particles have a size of less than 5 μm.

10. The radiation detector as claimed in claim 3, wherein particles of TiO₂ are contained in the binding agent matrix.

11. The radiation detector as claimed in claim 10, wherein the particles have a size of less than 5 μm.

12. The radiation detector as claimed in claim 2, wherein the microcavities are formed by an additive that is added to the binding agent matrix in its flowable initial state and at least one of produces gas and is transformed into a gaseous state.

13. The radiation detector as claimed in claim 3, wherein the microcavities are formed by an additive that is added to the binding agent matrix in its flowable initial state and at least one of produces gas and is transformed into a gaseous state.

14. The radiation detector as claimed in claim 4, wherein the microcavities are formed by an additive that is added to the binding agent matrix in its flowable initial state and at least one of produces gas and is transformed into a gaseous state.

15. The radiation detector as claimed in claim 5, wherein the microcavities are formed by an additive that is added to the binding agent matrix in its flowable initial state and at least one of produces gas and is transformed into a gaseous state.
